(19) United States
(12) Patent Application Publication
(10) Pub. No.: US 2017/0050382 A1
(43) Pub. Date: Feb. 23, 2017

(54) Closed-Loop 3D Printing Incorporating Sensor Feedback

(71) Applicant: Voxel8, Inc., Somerville, MA (US)

(72) Inventors: John Minardi, Somerville, MA (US); Jonathan Tran, Somerville, MA (US)

(21) Appl. No.: 15/241,948

(22) Filed: Aug. 19, 2016

Related U.S. Application Data
(60) Provisional application No. 62/208,222, filed on Aug. 21, 2015.

(51) Int. Cl. B29C 67/00; B28B 1/00; B33Y 50/02; B33Y 10/00; B33Y 30/00

(52) U.S. Cl. CPC B29C 67/0088; B29C 67/0059; B33Y 10/00; B33Y 30/00; B33Y 50/02; B28B 1/001

(57) ABSTRACT

A three-dimensional (3D) printer and method of 3D printing including receiving a 3D model of an object to be printed, receiving information including material properties of the materials to be extruded, and generating a set of sensor-based printer control parameters to print the object on the 3D printer based, at least in part, on sensor input.

### RELATED APPLICATION

This application claims priority to and the benefit of, and incorporates herein by reference in its entirety, U.S. Provisional Patent Application No. 62/208,222, which was filed on Aug. 21, 2015.

### FIELD OF THE INVENTION

Embodiments of the invention relate to systems for and methods of three-dimensional (3D) printing and, more specifically, to a 3D printer adapted to incorporate feedback from at least one sensor updating the internal path-plan representation mid-print or on-the-fly.

### BACKGROUND

Prior to initiation of printing, conventional 3D printers, e.g., printer hardware and software, typically build a computational model of each slice or layer of the entire 3D printing process. For example, conventional 3D printers may select printer parameters, e.g., nozzle temperature, layer height, in-fill patterns, maximum speed, maximum acceleration, and so forth, beforehand, taking into account expected properties of the input materials. However, conventional 3D printers generally do not account for variances of the material properties, e.g., when a new source material is input into the printer system, and/or the impact of the interaction between the new input materials and the various components of the 3D printer or the environment in which the 3D printer is printing.

For those few conventional 3D printers that do provide for sensing material and/or tool properties during printing, optical imaging devices, e.g., cameras, are exclusively used. For example, optical imaging devices may be used to identify surface defects, dimensional inaccuracies that fall outside of acceptable tolerances, and similar failure modes. The solution for these failure modes, typically, requires interrupting the printing process, shutting down the printer, and removing and disposing of the defective printed object.

### SUMMARY

Conventional 3D printers are not able to sense and process material property or other printing data from sensors and to update the internal path-plan representation mid-print or on-the-fly, without shutting down the printer. Accordingly, there is a need for a reliable 3D printer and printing system adapted to print objects that satisfy required tolerances by incorporating sensor-based feedback to update the internal path-plan representation mid-print or on-the-fly, to produce objects in an efficient manner with a high throughput and low user interaction.

In an aspect, an embodiment of the invention includes a computer-implemented method for 3D printing. The method includes receiving, by a processing device, a 3D model of an object to be printed; receiving, by the processing device, information including at least one material property of a material to be three-dimensionally printed; and generating, by the processing device, a set of sensor-based printer control parameters to print the object based, at least in part, on the sensor input.

In some implementations, the set of printer control parameters may include a head path and at least one printing property. In some implementations, the method may further include initiating 3D printing of the object in the 3D printer; receiving, during 3D printing, information from at least one sensor associated with the 3D printing; and adjusting a printing property based on the sensor information. The printing property may be adjusted without stopping the 3D printing.

In some implementations, the printing property to be modified based on sensor feedback may include head speed, extrusion speed, head temperature, dwell time before, during, or after printing, applied extrusion, retraction technique, minimum nozzle size, minimum layer thickness, and maximum layer thickness, minimum particle density, or maximum particle height. In some variations, the extrusion pressure may be applied pneumatically or volumetrically. The material property may be identified experimentally or theoretically. In some implementations, the printer includes multiple printing heads and each printing head is adapted to output a material with different material properties.

In some embodiments, the material property of the material to be printed may be viscosity, density, strength, yield stress, melting temperature, melting pressure, glass transition temperature, solvent evaporation rate, average particle size, largest particle size, or permeability of a solvent.

In some embodiments, generating a set of sensor-based printer control parameters includes slicing the 3D model into a number of ordered layers. In some variations, generating a set of sensor-based printer control parameters includes generating a set of sensor-based printer control parameters for each ordered layer. In some implementations, each ordered layer includes one or more polygons or polylines. In some embodiments, generating the set of sensor-based printer control parameters includes optimizing printer head travel paths. In some variations, generating the set of sensor-based printer control parameters and optimizing printer head travel paths includes combining printer head movements with extrusion commands.

In some implementations, the method may further include exporting a generated sensor-based printer control parameter to the 3D printer, wherein the sensor-based printer control parameter is storable as a variable and resolving the variable into a value set.

In some implementations, the received information may further include image information received from an optical camera, an imaging device, or an in-line imaging device, and the method may further include comparing the received image information to an expected image. In some variations, the method includes adjusting a rate of extrusion, based on the comparison of the received and expected images.

In another aspect, an embodiment of the invention includes a non-transitory computer program product embodied on a computer-readable medium and including computer code for 3D printing. The code includes instructions executable by a processing device for receiving a 3D model of an object to be printed; receiving, by the processing device, information including at least one material property of a material to be three-dimensionally printed; and generating, by the processing device, a set of sensor-based printer control parameters to print the object by a 3D printer based at least in part on a sensor input.

In yet another aspect, an embodiment of the invention includes a 3D printing system. The system includes a processing device; and a 3D printer including a dispensing system and a sensor. The processing device is adapted to execute instructions including a set of sensor-based printer control parameters to print an object based at least in part on input from the sensor.

In some implementations, the processing device is further adapted to execute instructions for initiating 3D printing of the object in the 3D printer; receiving, during 3D printing, the input from the sensor associated with the 3D printing; and adjusting at least one printing property based on the sensor input. In some variations, the sensor is a force probe, a weight sensor, an optical camera, an imaging device, an in-line imaging device, a profilometer, a laser measurement device, a 3D scanner, or an automatic digital multimeter.

In some implementations, the processing device is further configured to compare an image received from the optical camera, the imaging device, or the in-line imaging device with an expected image. In other variations, the system includes an extrusion multiplier adapted to adjust a rate of extrusion based on a comparison of the received and expected images. In some implementations, the sensor is mounted on a dispensing system of the 3D printing system. In other variations, the processing device is adapted to execute instructions including receiving, by the processing device, a three-dimensional model of an object to be printed and receiving, by the processing device, information including a material property of a material to be three-dimensionally printed.

### BRIEF DESCRIPTION OF DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows a block diagram of an illustrative embodiment of a 3D printing system in accordance with some embodiments of the present invention;

FIG. 2 shows a block diagram of an illustrative embodiment of a 3D printer in the printing system of FIG. 1;

FIG. 3 shows a perspective view of an illustrative embodiment of the 3D printer of FIG. 2;

FIG. 4A shows a side view of an illustrative embodiment of a dispensing system in the 3D printer of FIG. 3;

FIG. 4B shows a perspective view of the illustrative embodiment of a dispensing system of FIG. 4A;

FIG. 5 shows a perspective view of an illustrative embodiment of a dispensing tip for the dispensing system of FIG. 3; and

FIG. 6 shows a flow chart of an illustrative embodiment of a 3D printing method in accordance with some embodiments of the present invention.

### DETAILED DESCRIPTION

Embodiments of the invention include a 3D printer and 3D printing system that include the system, hardware, electronics, input materials, and at least a portion of the software needed to three-dimensionally print an object and, more specifically, an object having at least one material property and, in some implementations, a plurality of input materials having a least one different material property. Advantageously, the 3D printer uses sensor-based data from at least one sensor to update a printing head path-plan and machine commands to print a 3D object.

### Three-Dimensional (3D) Printing System

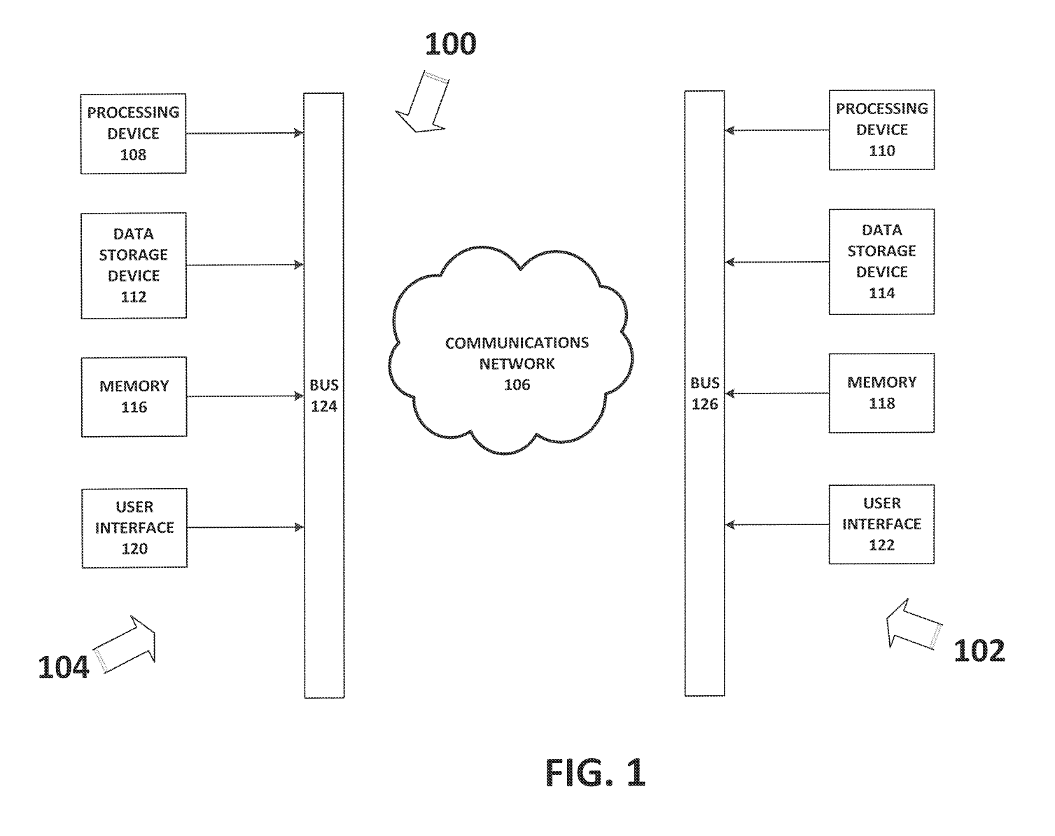

Referring to FIG. 1, in an illustrative embodiment, a 3D printing system 100 may include a 3D printer 102 and a remote server (processing device) 104 that are in communication via a communications network 106. The communications network 106 generally connects a client with a server, and, in the case of peer-to-peer communications, may connect two peers. Communication may take place via any medium such as a public-switched telephone network (PSTN), a wired or wireless local area network (LAN) or a wired or wireless wide area network (WAN) links (e.g., T1, T3, 56 kb, X.25), broadband connections (e.g., ISDN, Frame Relay, ATM), wireless personal area network (PAN), wireless links (e.g., 802.11, Bluetooth, Zigbee, IrDa, or other suitable protocol), and so on. To exchange data via the communications network 106, the processing devices and communications network 106 may use various methods, protocols, and standards, including, inter alia, token ring, Ethernet, TCP/IP, UDP, HTTP, FTP, and SNMP. Thus, the communications network 106 may carry, for example, TCP/IP, UDP, OSI or other protocol communications, and HTTP/HTTPS requests made by a Web browser and the connection may be made between the peers and communicated over such TCP/IP networks. Those of ordinary skill in the art can appreciate those plural communications networks 106 may also be used by the remote server 104 and the 3D printer 102.

The type of communications network 106 is not a limitation, however, and any suitable network may be used. Non-limiting examples of networks that can serve as, or be part of, the communications network 106 include a wireless or wired Ethernet-based intranet, a LAN or WAN, and/or the global communications network known as the World Wide Web and/or the Internet, which may accommodate many different communications media and protocols.

When used in a LAN networking environment, processing devices may be connected to the LAN through a network interface or adapter. When used in a WAN networking environment, processing devices typically include a modem or other communication mechanism. Modems may be internal or external, and may be connected to a system bus, e.g., via a user-input interface, or other appropriate mechanism. Processing devices may also be connected over the Internet, an Intranet, Extranet, Ethernet, or any other system that provides communications. Furthermore, components of the system may communicate through a combination of wired or wireless paths.

Those skilled in the art may appreciate that embodiments of the invention may be practiced with various computer system configurations, including multiprocessor systems, microprocessor-based or programmable consumer electronics, minicomputers, mainframe computers, and the like. Embodiments of the invention may also be practiced in distributed computing environments where tasks are performed by remote processing devices that are linked through the communications network 106. In a distributed computing environment, program modules may be located in both local and remote computer storage media including memory storage devices.

In some embodiments, each of the 3D printer 102 and the remote server 104 may include a processing device 108, 110; a data storage device 112, 114; memory 116, 118; and a user interface 120, 122. The processing device 108, 110 may include an operating system that manages at least a portion of the hardware elements included therein.

The processing device 108, 110 may be adapted to perform or execute a series of instructions, e.g., an application, an algorithm, a driver program, and the like, that result in manipulated data. There are many examples of processing devices 108, 110 including, for the purpose of illustration and not limitation, network appliances, personal computers, workstations, mainframes, networked clients, servers, media servers, application servers, database servers, and web servers. The processing device 108, 110 may be a commercially available processor such as an Intel Core, Motorola PowerPC, MIPS, UltraSPARC, or Hewlett-Packard PA-RISC processor, but also may be any type of available processing device 108, 110 or controller.

Certain aspects and functions of embodiments of the present invention may be located on a single processing device 108, 110 or system 100 or may be distributed among a plurality of processing devices 108, 110 or systems 100 connected to one or more communications networks 106. For example, various aspects and functions may be distributed among one or more processing systems 110 configured to provide a service to one or more client computers, or to perform an overall task as part of a distributed system. Additionally, aspects may be performed on a client-server 108 or multi-tier system that includes components distributed among one or more server systems 110 that perform various functions. Thus, the invention is not limited to executing on any particular system or group of systems. Moreover, aspects may be implemented in software, hardware or firmware, or any combination thereof. Thus, aspects in accord with the present invention may be implemented within methods, acts, systems, system elements, and components using a variety of hardware and software configurations, and the invention is not limited to any particular distributed architecture, network, or communication protocol.

Typically, a processing device 108, 110 executes an operating system that may be, for example, a Windows-based operating system (e.g., Windows 7, Windows 2000 (Windows ME), Windows XP operating systems, and the like) available from the Microsoft Corporation of Seattle, Wash.; a MAC OS System X operating system available from Apple Computer of Cupertino, Calif.; a Linux-based operating system distributions (e.g., the Enterprise Linux operating system) available from Red Hat, Inc. of Raleigh, N.C.; or a UNIX operating system available from various sources. Many other operating systems may be used, and embodiments are not limited to any particular implementation. Operating systems conventionally may be stored in memory 116, 118.

The processing device 108, 110 and the operating system together define a processing platform for which application programs in high-level programming languages may be written. These component applications may be executable, intermediate (for example, C−) or interpreted code which communicate over a communication network (for example, the Internet) using a communication protocol (for example, TCP/IP). Similarly, aspects in accordance with the present invention may be implemented using an object-oriented programming language, such as SmallTalk, Java, C++, Ada, or C# (C-Sharp). Other object-oriented programming languages may also be used. Alternatively, functional, scripting, or logical programming languages may be used. For instance, aspects of the system may be implemented using an existing commercial product, such as, for example, Database Management Systems such as SQL Server available from Microsoft of Seattle, Wash., and Oracle Database from Oracle of Redwood Shores, Calif. or integration software such as Web Sphere middleware from IBM of Armonk, N.Y. However, a processing device 108, 110 running, for example, SQL Server may be able to support both aspects in accordance with the present invention and databases for sundry applications not within the scope of the invention. In one or more of the embodiments of the present invention, the processing device 108, 110 may be adapted to execute at least one application, algorithm, driver program, and the like. The applications, algorithms, driver programs, and the like that the processing device 108, 110 may process and may execute can be stored in memory 116, 118.

Memory 116, 118 may be used for storing programs and data during operation of the processing devices 108, 110. Memory 116, 118 can be multiple components or elements of a data storage device(s) 112, 114 or, in the alternate, can be stand-alone devices. More particularly, memory 116, 118 can include volatile storage, e.g., random access memory (RAM), and/or non-volatile storage, e.g., a read-only memory (ROM). The former may be a relatively high performance, volatile, random access memory such as a dynamic random access memory (DRAM) or static memory (SRAM). Various embodiments in accordance with the present invention may organize memory 116, 118 into particularized and, in some cases, unique structures to perform the aspects and functions disclosed herein. Advantageously, memory 116, 118 may include software for 3D modeling and head path-planning for 3D printing purposes. The software may be uploaded in the memory 116 of the remote server 104 or, in the alternative, in the memory 118 associated with of the 3D printer 102.

User-input interfaces 120, 122, e.g., graphical user interfaces (GUI) and the like, provide a vehicle for human interaction, with a machine, e.g., the processing device 108, 110, in which the human user provides input to direct the machine's actions while the machine provides output and other feedback to the user for use in future input. User-input interfaces 120, 122 are well known to the art and will not be described in detail.

Components of the processing device 108, 110 may be coupled by an interconnection element such as a bus 124, 126. The bus 124, 126 may include one or more physical busses, e.g., between components that are integrated within a same machine, but may also include any communication coupling between system elements, e.g., specialized or standard computing bus technologies such as IDE, SCSI, PCI, and InfiniBand. Thus, the bus 124, 126 enables communications, e.g., the transfer of data and instructions, to be exchanged internally, between printer 102 and system 100 components.

### Three-Dimensional (3D) Printer

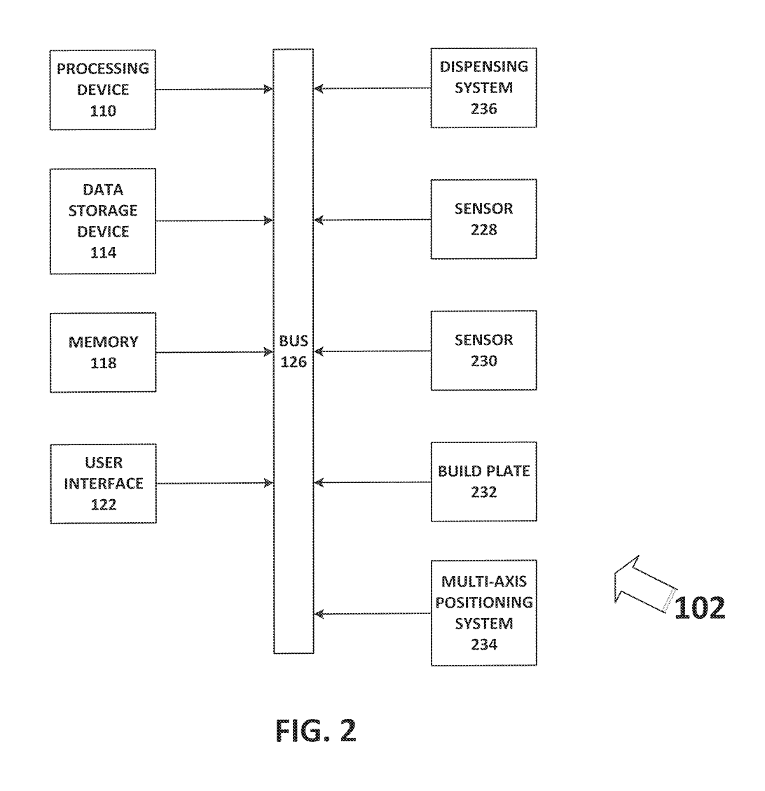

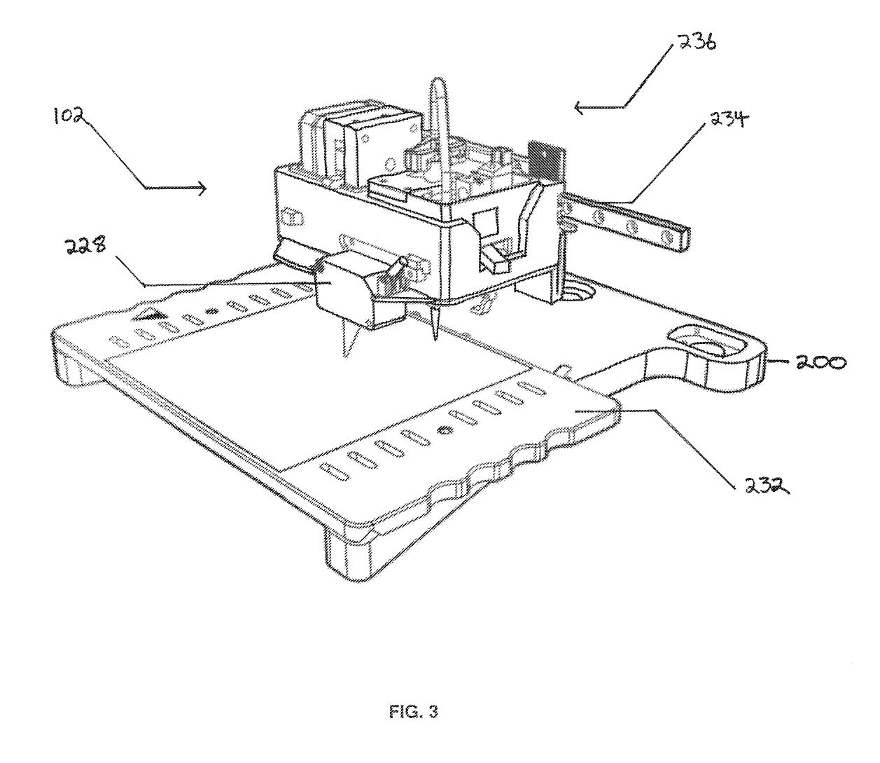

Referring to FIG. 2, in addition to the processing device 110, data storage device 114, memory 118, and user interface 122 described previously, the 3D printer 102 may also include one or more sensors 228, 230, a build plate 232, a multi-axis positioning system 234, and a dispensing system 236 including a printer head. Referring also to FIG. 3, the build plate 232 may be disposed below the dispensing system 236 and configured to provide a planar and level surface for 3D printing. In some implementations, the build plate 232 may be supported on a frame 200, e.g., by a kinematic coupling, to be removable and accurately replaced, even during a build cycle of a single object. See also U.S. Patent Application Publication No. 2016/0193785 A1 (U.S. Ser. No. 14/986,373), the disclosure of which is incorporated herein by reference in its entirety. In operation, the build plate 232 may translate vertically, e.g., in the z-axis, by a lead screw, ball nut, stepper motor, and the like (e.g., riding along vertically disposed metal rails using spaced brass bushings for low friction and ease of travel). Similarly, the dispensing system 236 may translate throughout a horizontal plane (along x-y axes) to permit printing across the entire build plate 232. An example of a commercially available 3D printer having such features is the Developer's Kit 3D Printer, available from Voxel8, Inc., based in Somerville, Mass.

The multi-axis positioning system 234 is adapted to position the dispensing system 236 and, more specifically, position dispensing tips of removable cartridges disposed in the dispensing system, in multiple axes, e.g., two to three-axes, relative to the frame 200 and build plate 232 reliably and repeatably. In some implementations, the multi-axis positioning system 234 moves the dispensing tips relative to the build plate 232 to position the dispensing tips and to dispense a heated filament or other build material in a programmed geometry and according to the head path-plan to create the printed object. An exemplary multi-axis positioning is system is the ABG Gantry manufactured by Aerotech Inc., based in Pittsburgh, Pa.

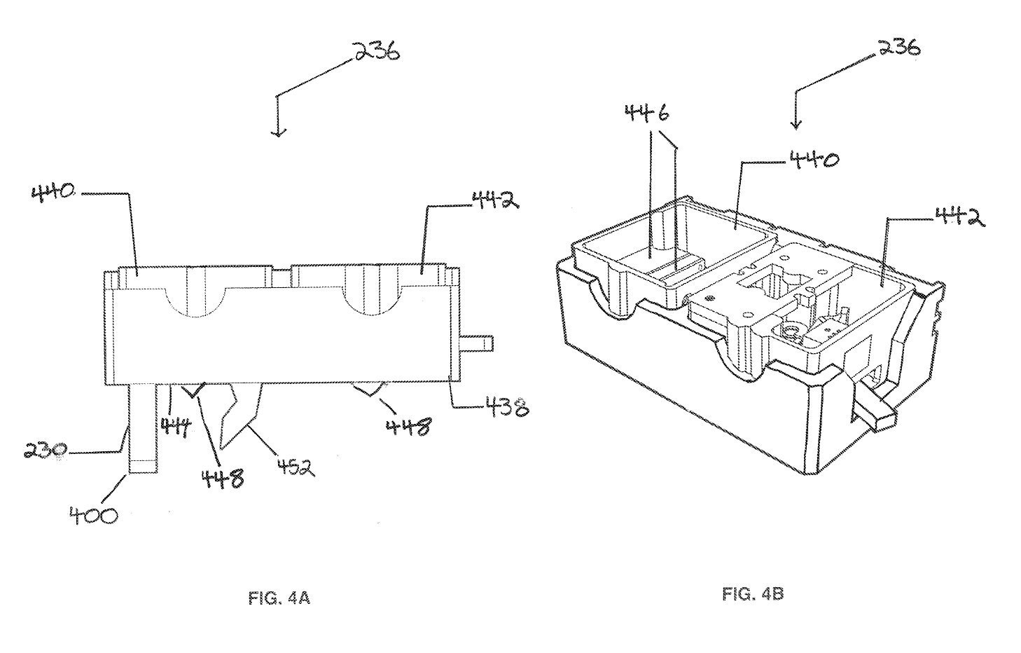

Referring also to FIG. 4A, in some variations, the 3D printer 102 may include one or more sensors 228, 230, e.g., a force probe, a weight sensor, an optical camera, an imaging device, an in-line imaging device, a profilometer, a thermometer, a 3D scanner, a laser measurement device, an automatic digital multimeter, and so forth. A first sensor 228 may be configured for sensing one or more properties of extrudable materials, prior to initiation of a printing operation. A second sensor 230 may be configured for sensing and collecting data on various components of the 3D printer 102 and/or on the print product while the printing operation is on-going. In some embodiments, material property data, e.g., one or more of viscosity, density, strength, yield stress, melting temperature, melting pressure, glass transition temperature, average particle size, largest particle size, solvent evaporation rate, and solvent permeability, may be combined, by at least one of the processing devices 108, 110, with printing properties, e.g., head speed, extrusion speed, head temperature, dwell time before, during, or after printing, applied extrusion pressure, retraction technique, minimum nozzle size, minimum layer thickness, maximum layer thickness, and so forth, to compose a head path-plan that includes initial selective printer parameters, e.g., nozzle temperature, layer height, in-fill patterns, maximum speed, maximum acceleration, and so forth. To accurately position the material on the bed, a bed level sensor 400 (induction sensor, laser profilometer, etc.) may be used to measure the vertical offset between the nozzle tip and the bed.

Referring to FIGS. 3, 4A, and 4B, the dispensing system 236 may include a cartridge holder 438 that is adapted to hold multiple, e.g., two or more, removable cartridges 440, 442, each cartridge 440, 442 containing an extrudable or printable material to form the 3D object and, typically containing materials having at least one different material property, e.g., viscosity, density, strength, yield stress, melting temperature, melting pressure, glass transition temperature, average particle size, largest particle size, solvent evaporation rate, solvent permeability, and so forth, of the extruded materials. Suitable exemplary removable cartridges are manufactured by Voxel8, Inc., based in Somerville, Mass.

For example, in one implementation, one of the removable cartridges 440 may be adapted to extrude a heated filament, e.g., a polymer, a composite, a ceramic, a fused filament fabrication (FFF)/matrix material, a thermoplastic (e.g., ABS, PLA, ULTEM thermoplastic-based filament), and the like, and the other cartridge 442 may be adapted to extrude an electrically conductive material, e.g., room temperature silver or other electrically conductive particles in a solvent-based slurry.

More particularly, the first cartridge 440 may be adapted to push or pull a first material through a heated end 444 (i.e., hot end) of a dispensing tip 448 (also referred to herein as a nozzle). A heating device heats up the filament sufficiently at the heated end 444 to put it into a liquid or semi-liquid state. While the heating device is heating the extrudable material, heat removal devices, e.g., one or more cooling fans 446, a heat exchange device, and the like, may cool the portion of the first cartridge 440 that is not near the heated end 444. The multi-axis positioning system 234 moves the dispensing tip relative to the build plate 232 and frame 200 to position the dispensing tip and to dispense the heated filament, respectively, in a programmed geometry and according to the printing head path-plan to create the printed object.

The second cartridge 442 may be adapted for dispensing, e.g., pneumatically, a second material, e.g., a mixture of a functional ink, such as conductive, magnetic, dielectric, and/or semiconductor materials (e.g., room temperature silver), and a matrix ink, such as epoxy, silicones, thermoplastic urethane, or combinations thereof, having at least one material property that differs from the first material in the first cartridge 440.

The cartridge holder may include a fan shroud 452. The fan shroud 452 may be adapted to direct the air produced by the fan to a specific location to ensure adequate cooling of the extruded material.

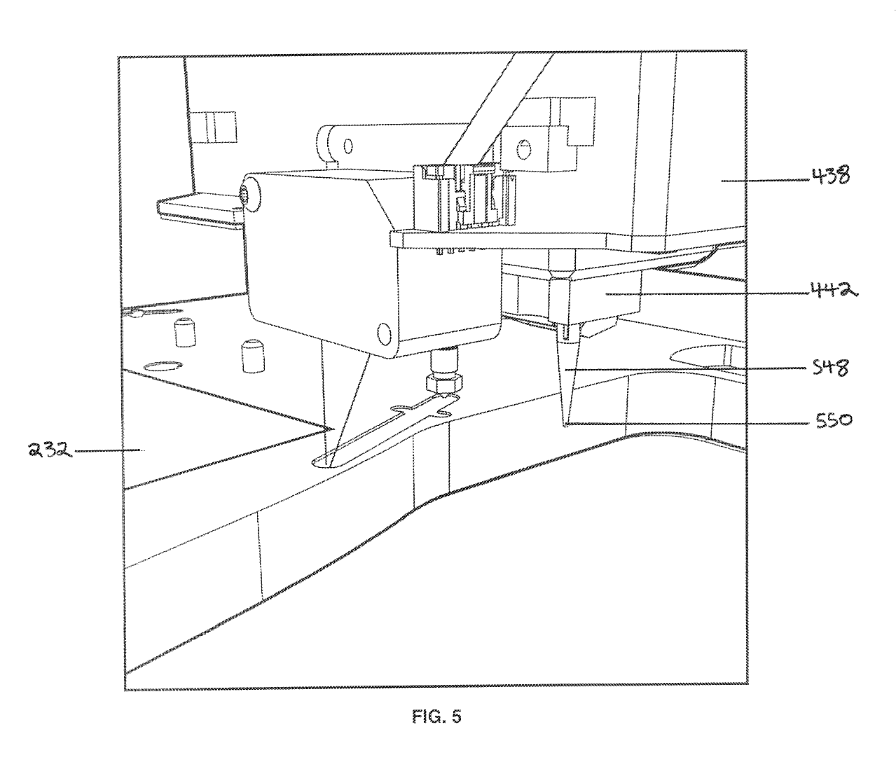

Referring to FIG. 5, each cartridge 440, 442 may include a hollow dispensing tip 548 that is adapted to accurately deliver the extrudable material via an opening 550 at a distal end of the dispensing tip 548. The dimensions of the opening 550 and of the hollow dispensing tip 548 may vary, depending on the material being extruded and the necessary precision of the build object.

### Method of Three-Dimensional (3D) Printing

A vast majority of contemporary 3D printers executes printing commands and performs head path-planning using a numerical control programming language known as GCode. Indeed, GCode remains an industry standard for controlling automated machine tools, during computer-assisted manufacturing. However, programming techniques can be employed advantageously to transform user-input parameters into printing parameters and, moreover, into head path-planning.

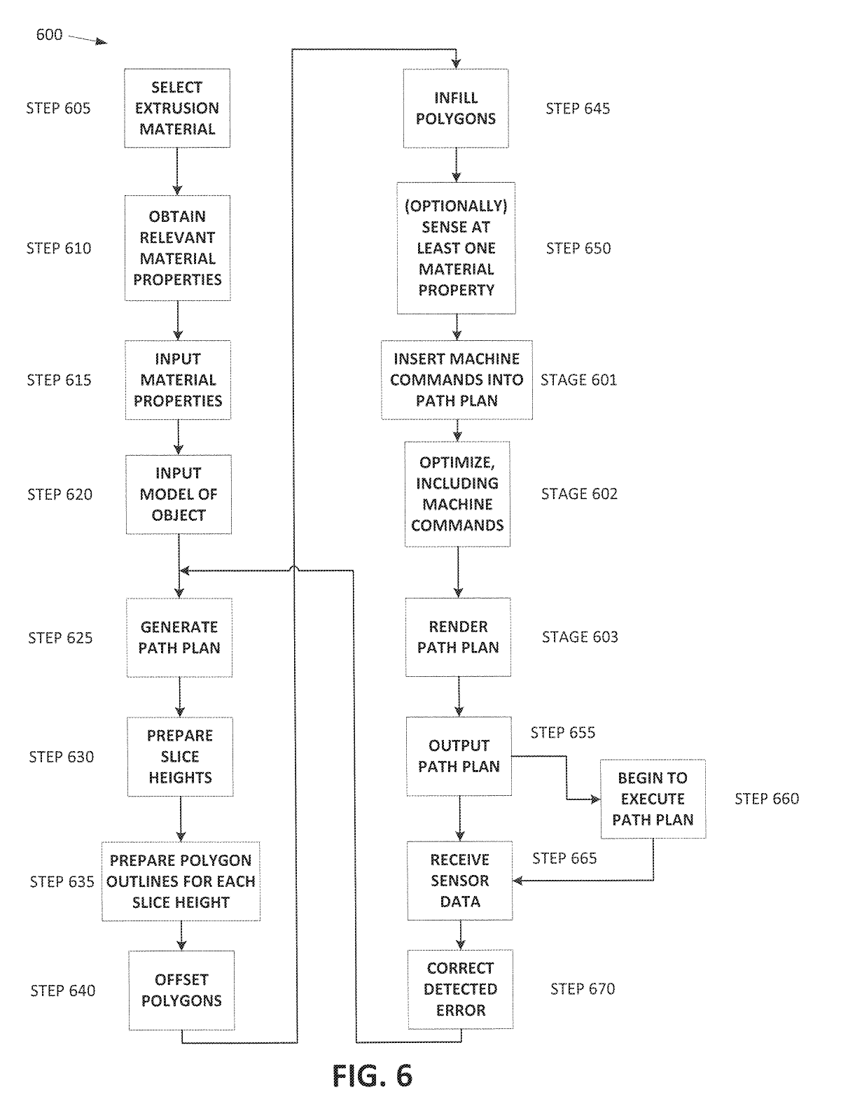

Referring to FIG. 6, a closed-loop computer-implemented method for 3D printing in accordance with embodiments of the present invention is shown. Once a user designates or selects a material(s) to be extruded via a 3D printing operation (STEP 605), the user may obtain, e.g., experimentally, empirically, or theoretically, relevant material properties (STEP 610). Some relevant material characteristics or material properties may include, for the purpose of illustration and not limitation: density, strength, viscosity, yield stress, electrical conductivity, thermal conductivity, melting temperature, average particle size, largest particle size, solvent permeability, solvent evaporation rate, glass transition temperature, and various other rheological properties. The relevant material properties, as well as a description of each property, may be input or entered (STEP 615), e.g., using a graphical user interface (GUI), into the processing device, or read into the processing device from a file stored in memory.

The user may also upload to the processing device a 3D model of the object to be printed (STEP 620) using the selected extrudable material(s). Advantageously, the 3D model of the object to be printed may be uploaded locally or remotely but processed remotely by the remote server, e.g., using 3D model slicing and head path-planning software. Model slicing processing and path-planning remotely reduce the storage, execution speed, and similar requirements for the local processing device associated with the 3D printer. Notwithstanding, in some variations, processing may be accomplished locally on the 3D printer's processing device

The processing device (remote or local) may be configured to process the input 3D model and material properties that it received to generate a set of sensor-based printer control parameters, such as an executable head path-plan (STEP 625) suitable for printing and that includes various output printing control parameters. Printing control parameters from such user input properties may include, for the purpose of illustration and not limitation: dispensing tip speed, extrusion speed, dispensing tip temperature, dwell time before, during, or after printing, pneumatically applied extrusion pressure, volumetrically applied extrusion pressure, minimum nozzle size, minimum layer thickness, maximum layer thickness, minimum part density, retraction technique employed, and various other printing parameters.

Generating a computer-executable path-plan (STEP 625) suitable for 3D printing and that takes into account the various sensor-based printer control parameters may include sub-steps including standard data flow for slicing the model associated with additive manufacturing into ordered layers (also referred to herein as ordered slices), viz. prepare the 3D mesh for each ordered layer or slice (STEP 630), prepare polygon/polyline outlines for each ordered layer or slice such that each ordered layer or slice includes at least one polygon and/or at least one polyline (STEP 635), offset the polygons on each ordered layer or slice (STEP 640), and in-fill the polygons on each layer or slice with the material(s) (STEP 645). These steps are well known to those skilled in the pertinent art and will not be discussed in detail. Advantageously, each of steps 630 through 645 takes into account one or more of the material properties of each of the materials being extruded.

As used herein, a polygon is a two-dimensional shape defined by a plurality of end-to-end connected straight line segments or arc segments, where the start of the first line segment or arc segment is connected to the end of the last line segment or arc segment. As used herein, a polyline is a polygon without the constraint of connected start and end points.

Generating the set of sensor-based printer control parameters may include optimizing printer head travel paths. This may include combining printer head movements with extrusion commands.

A generated printer control parameter may be exported to the 3D printer, with the sensor-based printer control parameter being storable as a variable, and the variable may be resolved into a value set. For example, the generated path plan may include an extrusion pressure that is a function of a sensed material property. Before the print is started, the material property may be sensed and the pressure needed to extrude is then calculated using the function.

Conventional systems typically transition from polygon in-fill (STEP 645) to generating and outputting GCode path-planning instructions (STEP 655); however, advantageously, the embodied method provides additional steps and stages that enable adjusting the path-plan and controlling printer parameters on-the-fly, without having to interrupt the printing operation or shut down the printing process altogether, to compensate for sensed material properties and changes in conditions during printing.

More specifically, embodiments of the present invention utilize a processing device adapted to use head path-plan and printer control techniques that differ from those traditionally used with GCode. For example, in some embodiments, prior to generating (STEP 625) and outputting a head path-plan (STEP 655), one or more material properties of at least one of the materials to be extruded is sensed (STEP 650). The resulting material property data are provided to the remote or local server for incorporation in the rendered head path-plan (STEP 625).

In summary, in some implementations, embodiments of the present invention may use actual sensed material property data in formulating the initial path-plan. Moreover, during 3D printing, the processing device may use various information sensed by one or more sensors to make on-the-fly adjustments to the head path-plan, without having to stop the printing process or reject printed products. For example, an input glass transition temperature may be mapped to an extruder temperature via direct linear scaling. Look-up tables (LUTs) containing historical input printing parameters may be re-used when the same or similar materials having the same or similar material properties are used. In some instances, general printing knowledge, prior experimentation, and other heuristics may be used to map input material properties to printing control parameters over a sufficiently useful domain. In other instances, especially with those instances involving novel materials, print test patterns that include variations of estimated printing control parameters may be used to provide empirical best working parameters.

In a first stage of one embodiment of the disclosed improvement to 3D printing, higher level 3D printer (hereinafter machine) commands that are associated more closely with the 3D printer than with the resulting 3D product, e.g., wipe dispensing tip, switch dispensing tip, control fan, control temperature, control display LED, and so forth, may be included in one or more appropriate layers in the path-plan (STAGE 601). As a result, during STAGE 601, between printing of a first ordered layer and a second ordered layer, a “wipe dispensing tip” command may cause the dispensing system, before moving on to the second ordered layer, to displace to a designated wipe station, where various wipe actions on the dispensing tip may be performed, e.g., to remove excess material from the outer surface of the dispensing tip and the opening. An exemplary wipe station model is the PICO Jet Valve Cleaning Station, available from Nordson EFD, based in East Providence, R.I.

In a second stage, the effects of the machine commands vis-à-vis the initial head path-plan may be optimized (STAGE 602) to ensure that a resulting path-plan is optimized for the given constraints. For example, an exemplary constraint may minimize travel moves, by which the printing head is moved without extruding material, providing the shortest path routes for each ordered layer. Another example of optimization constraints may include changing an order of occurrence of an ordered layer to print an innermost perimeter polygon as the first element of the ordered layer and the outermost perimeter polygon as the last element of the ordered layer, e.g., to leave the dispensing tip closer to the designated wipe station. Hence, STAGE 602 may require a re-ordering of the input polygons/polylines (STEP 635), in-fills (STEP 645), and machine commands (STAGE 601).

In a final stage, the optimized path-plan is reduced to general move and extrude commands for the dispensing system while higher level machine commands, e.g., wipe, are reduced to move commands for the 3D printer component involved and the path-plan is rendered (STAGE 603) and the initial path-plan is initiated (STEP 655) and executed (STEP 660).

Advantageously, embodiments of the present invention are closed-loop to incorporate feedback, e.g., sensor data, gathered before, during, or after printing, for the purpose of updating or modifying the on-going head path-plan on-the-fly, without having to interrupt or stop altogether the on-going printing operation. As a result, the closed-loop with sensor-based feedback enables and facilitates adaptation of the 3D printer to differing environments that might otherwise, on other printers, cause a catastrophic failure in the printing. Representative adjustments to the head path-plan may include, for the purpose of illustration and not limitation, changing one or more of: dispensing tip speed, extrusion speed, dispensing tip temperature, dwell time before, during or after printing, pneumatically applied extrusion pressure, volumetrically applied extrusion pressure, minimum nozzle size, minimum layer thickness, maximum layer thickness, minimum part density, retraction technique employed, and various other printing parameters.

For example, one or more sensors, e.g., a force probe, a weight sensor, an optical camera, an imaging device, an in-line imaging device, a profilometer, a 3D scanner, a laser measurement device, an automatic digital multimeter, and the like, may be utilized to sense and transmit sensor data and/or material property data to the processing device (STEP 665) where these data may be analyzed to detect faults or irregularities and introduced back into the path-plan to correct the fault or irregularity (STEP 670) on-the-fly. For example, a laser profilometer may be adapted to sense the width of the output filament (STEP 665), and the sensed data, e.g., undersized filaments, may be analyzed by the processing device and a corrective action taken, e.g., increase extrusion multiplier, to account for and/or compensate for the detected error (STEP 670). As used herein, an extrusion multiplier is a number by which the calculated extrusion rate is multiplied by to achieve the final extrusion rate. An increased extrusion multiplier causes the machine to output more material per unit time.

For example, the sensor data may also be used to detect completely failed features, such as a missed polyline due to a clogged nozzle. In this instance the present invention may regenerate a path plan for those missed featured and re-execute after running the nozzle clean machine command.

In another example, an on-board optical imaging device trained at the opening at the distal end of the dispensing tip may sense and provide image data (STEP 665), which, when compared to an expected image, indicates that the dispensing tip requires cleaning. Accordingly, using such sensor-based data, the processing device may be configured to modify the path-plan to include an immediate machine command, e.g., a wipe action. As another example, the rate of extrusion may be adjusted based on a comparison of the received and expected images. In another example the received image may be analyzed using machine vision techniques to determine the cleanliness of the dispensing tip.

Table I provides a non-exhaustive summary of certain printer control parameter changes for various sensor-based data.

TABLE 1

| Sensor, Sensed Data | Changed Parameter |
|---|---|
| Profilometer, single point | Adjust layer height |
| Profilometer, profile of single trace | Adjust extrusion multiplier |
| Profilometer, detect gap | Adjust extrusion multiplier |
| Profilometer, detect gap | In-fill overlap |
| Profilometer, detect trace break | Add new polyline |
| Profilometer, detect misalignment between | Adjust tool offset |
| materials | |
| Force probe, detect weak layer | Strengthen layer by |
| | increasing thickness |
| Force probe, detect weak layer | Increase in-fill percentage |
| Optical camera, detect dirty nozzle | Wipe command repeated or |
| | updated |
| Optical camera, detect dimension mismatch | Adjust scale factor |
| Optical camera, detect excessive “ooze” | Adjust dispensing |
| | tip temperature |
| Optical camera, detect trace break | Add new polyline |
| Optical camera, detect model slumping | Adjust fan speed |
| Weight scale, detect too little weight | Adjust extrusion multiplier |
| Weight scale, detect too little weight | Wipe command repeated |
| | or updated |
| Automatic digital multimeter, detect trace | Add new polyline |
| break | |
| Automatic digital multimeter, detect high | Add new polyline |
| resistance | |
| Automatic digital multimeter, detect high | Adjust print speed |
| resistance | |
| Human Interface Device (e.g., keyboard, | Adjust extrusion pressure |
| mouse, etc.), user intent | |

For example, the profilometer may read 50 μm less than expected for the previously printer layer height. Assuming a layer height of 200 μm the next layer's extrusion multiplier is preferably increased by 33.3%. Accordingly embodiments of the invention can automatically, adaptively change the 3D printing process on-the-fly during 3D printing, to improve build object quality and conformance to requisite design standards. Yields are improved and rejects are eliminated in many instances.

Those skilled in the art will readily appreciate that all parameters listed herein are meant to be exemplary and actual parameters depend upon the specific application for which the methods, materials, and apparatus of embodiments of the present invention are used. It is, therefore, to be understood that the foregoing embodiments are presented by way of example only and that, within the scope of the appended claims and equivalents thereto, embodiments of the invention may be practiced otherwise than as specifically described. Various materials, geometries, sizes, and interrelationships of elements may be practiced in various combinations and permutations, and all such variants and equivalents are to be considered part of the invention.

What is claimed is:

1. A computer-implemented method for three-dimensional printing, the method comprising:
receiving, by a processing device, a three-dimensional model of an object to be printed;
receiving, by the processing device, information including at least one material property of a material to be three-dimensionally printed; and
generating, by the processing device, a set of sensor-based printer control parameters to print the object by a three-dimensional printer based at least in part on a sensor input.

2. The method of claim 1, wherein the set of printer control parameters comprises a head path and at least one printing property.

3. The method of claim 1 further comprising:
initiating three-dimensional printing of the object in the three-dimensional printer;
receiving, during three-dimensional printing, information from at least one sensor associated with the three-dimensional printing; and
adjusting at least one printing property based on the sensor information.

4. The method of claim 3, wherein the at least one printing property is adjusted without stopping the three-dimensional printing.

5. The method of claim 3, wherein the at least one printing property is selected from the group consisting of head speed, extrusion speed, head temperature, dwell time before, during, or after printing, applied extrusion pressure, retraction technique, minimum nozzle size, minimum layer thickness, maximum layer thickness, minimum particle density, and maximum particle height.

6. The method of claim 5, wherein extrusion pressure is applied at least one of pneumatically and volumetrically.

7. The method of claim 1, wherein the at least one material property is identified experimentally.

8. The method of claim 1, wherein the at least one material property is identified theoretically.

9. The method of claim 1, wherein the three-dimensional printer comprises a plurality of printing heads and each printing head is adapted to output a material with different material properties.

10. The method of claim 1, wherein the at least one material property is selected from the group consisting of viscosity, density, strength, yield stress, melting temperature, melting pressure, glass transition temperature, solvent evaporation rate, average particle size, largest particle size, and permeability of a solvent.

11. The method of claim 1, wherein generating the set of sensor-based printer control parameters comprises slicing the model into a plurality of ordered layers.

12. The method of claim 11, wherein generating the set of sensor-based printer control parameters comprises generating a set of sensor-based printer control parameters for each ordered layer.

13. The method of claim 11, wherein each ordered layer comprises at least one of one or more polygons and one or more polylines.

14. The method of claim 11, wherein generating the set of sensor-based printer control parameters comprises optimizing printer head travel paths.

15. The method of claim 14, wherein generating the set of sensor-based printer control parameters and optimizing printer head travel paths comprises combining printer head movements with extrusion commands.

16. The method of claim 1, further comprising:
exporting a generated printer control parameter to the three-dimensional printer, wherein the sensor-based printer control parameter is storable as a variable; and
resolving the variable into a value set.

17. The method of claim 1, wherein the received information further comprises image information received from at least one of an optical camera, an imaging device, and an in-line imaging device, the method further comprising comparing the received image information to an expected image.

18. The method of claim 17 further comprising adjusting a rate of extrusion based on a comparison of the received and expected images.

19. A non-transitory computer program product embodied on a computer-readable medium and comprising computer code for three-dimensional printing, the code comprising instructions executable by a processing device for:
receiving, by the processing device, a three-dimensional model of an object to be printed;
receiving, by the processing device, information including at least one material property of a material to be three-dimensionally printed; and
generating, by the processing device, a set of sensor-based printer control parameters to print the object by a three-dimensional printer based at least in part on a sensor input.

20. A three-dimensional printing system comprising:
a processing device; and
a three-dimensional printer comprising
at least one dispensing system; and
a sensor,
wherein the processing device is adapted to execute instructions comprising a set of sensor-based printer control parameters to print an object based at least in part on input from the sensor.

21. The system of claim 20, wherein the processing device is further adapted to execute instructions for:
initiating three-dimensional printing of the object in the three-dimensional printer;
receiving, during three-dimensional printing, the input from the sensor associated with the three-dimensional printing; and
adjusting at least one printing property based on the sensor input.

22. The system of claim 20, wherein the sensor is selected from the group consisting of a force probe, a weight sensor, an optical camera, an imaging device, an in-line imaging device, a profilometer, a laser measurement device, a 3D scanner, and an automatic digital multimeter.

23. The system of claim 22, wherein the processing device is further configured to compare an image received from at least one of the optical camera, the imaging device, and the in-line imaging device with an expected image.

24. The system of claim 23 further comprising an extrusion multiplier adapted to adjust a rate of extrusion based on a comparison of the received and expected images.

25. The system of claim 20, wherein the sensor is mounted on a dispensing system of the three-dimensional printing system.

26. The system of claim 20, wherein the processing device is further adapted to execute instructions comprising:
receiving, by the processing device, a three-dimensional model of an object to be printed; and
receiving, by the processing device, information including at least one material property of a material to be three-dimensionally printed.
